(19) United States
(12) Patent Application Publication
(10) Pub. No.: US 2026/0134019 A1
(43) Pub. Date: May 14, 2026

(54) DENSE CONTEXT ENGINE IN AN ARTIFICIAL INTELLIGENCE SYSTEM

(71) Applicant: Microsoft Technology Licensing, LLC, Redmond, WA (US)

(72) Inventors: Aditya VASAL, Redmond, WA (US); Adam Douglas Troy, Bothell, WA (US); Aleksandr Milanin, Bellevue, WA (US); Deepak Mishra, Everett, WA (US); Srinagesh Sharma, Long Island City, NY (US); Stefan Valianu, Redmond, WA (US)

(21) Appl. No.: 18/946,714

(22) Filed: Nov. 13, 2024

(51) Int. Cl. G06F 16/33; G06F 16/332

(52) U.S. Cl. CPC G06F 16/3344; G06F 16/3329

(57) ABSTRACT

Methods, systems, and computer storage media for providing dense context management using a dense context engine in an artificial intelligence (AI) system are described. Dense context management is a systematic approach that combines specific industry knowledge with contextual understanding to generate accurate, relevant, and specific industry-tailored responses to user queries. Dense context management includes dense context generation and contextual response generation using a programmatically-generated dense context. Dense context generation serves as a framework for extracting key findings and producing comprehensive dense context outputs across various documents. Contextual response generation serves as a framework for integrating the dense context into queries to reframe queries in a manner that makes it easier to generate more accurate and contextually relevant response. By leveraging the dense context, the dense context engine ensures that the responses are not only informed by general information but also tailored to the user's specific needs and the organizational environment.

### BACKGROUND

Users rely on Artificial Intelligence (AI) systems to efficiently retrieve and synthesize relevant information to generate insightful responses to their queries for informed decision making. An AI system is a platform designed to perform tasks that typically require human intelligence, such as understanding language, recognizing patterns, and making decisions, often through learning from data. In particular, it can analyze large datasets to identify trends and provide insights that assist in strategic planning. For example, an AI system can be a virtual assistant that understands spoken commands, manages schedules, and provides information by processing natural language input. An AI system can incorporate a Retrieval-Augmented Generation (RAG) framework as a transformative tool for organizations, enhancing knowledge management and decision-making. RAG features a comprehensive knowledge base sourced from internal and external data, allowing for quick and efficient information retrieval. When users pose questions, the AI system utilizes advanced algorithms to filter and rank relevant content.

### SUMMARY

Various aspects of the technology described herein are generally directed to systems, methods, and computer storage media for, among other things, providing dense context management using a dense context engine in an artificial intelligence (AI) system. An AI system supports generating answers to queries by retrieving relevant information from its knowledge base and using natural language processing to synthesize and articulate coherent, contextually appropriate responses. Dense context management is a systematic approach that combines specific industry knowledge with contextual understanding to generate accurate and relevant responses to user queries. Dense context management includes dense context generation and contextual response generation using the dense context. Dense context refers to a programmatically-generated concise representation of data that provides context for a language model to enhance the relevance and interpretability of queries. The concise representation of data removes non-essential information, such as exposition, filler words, or redundant content, while retaining the key points and core message for efficient comprehension. Dense context generation serves as a framework for extracting key findings and producing comprehensive community reports across various documents. Contextual response generation serves as a framework for integrating the dense context into queries to reframe queries in a manner that makes it easier to generate more accurate and contextually relevant responses. The dense context is employed within the constraints of the context window of the contextual response generation model. By leveraging the dense context, the dense context engine ensures that the responses are not only informed by general information but also tailored to the user's specific needs and the organizational environment.

Conventionally, AI systems are not configured with a comprehensive computing logic and infrastructure to efficiently and effectively respond to queries with dense context data having accurate (e.g., enterprise specific) context. Traditional fine-tuning and retrieval-augmented generation (RAG) methods for large language models (LLMs) face significant challenges in interpreting user queries in enterprise contexts. The complexity and redundancy of enterprise information, which is often fragmented across multiple sources, complicate effective retrieval. For example, in a large corporation with data scattered across multiple sources, using traditional fine-tuning and RAG methods can complicate retrieving coherent responses to queries like “customer feedback on product X.” If the query is negatively framed, such as “issues with product X,” it may lead to skewed results. Additionally, if the underlying embedding model lacks sophistication, it may not capture the query's nuances, resulting in irrelevant answers.

Additionally, post-training processes require carefully designed methodologies to integrate new knowledge while preserving existing capabilities, as flawed approaches can lead to catastrophic forgetting or degraded performance. The precision of query formulation is also crucial, as adversarial queries can yield negative results. These issues highlight the need for context-aware retrieval strategies that align model outputs with the specific requirements of enterprises. While RAG can effectively extract information when given well-structured queries, its performance is limited by the quality of embedding models, which often lack the flexibility of LLMs. Effective post-training can enhance reasoning and memorization within a specific corpus, but achieving this balance requires meticulous planning. Overall, improving LLMs for enterprise use demands innovative strategies to enhance context interpretation, refine query formulation, and optimize post-training methodologies.

A technical solution—to the limitations of conventional AI—can include providing a dense context engine resources via an AI system that supports dense context management in the AI system. The dense context engine resources (e.g., data, operations, and interfaces) support document understanding and improve responses to user queries in organizations. Data of the dense context engine resources can include a comprehensive document corpus, contextual metadata, and user profiles to tailor outputs to specific needs. Operations of the dense context engine resources can include dense context generation, which extracts key findings and summarizes essential information from documents using natural language processing techniques; and contextual response generation, which enriches user queries with relevant contextual information to produce accurate and context-aware answers. Interfaces of the dense context engine resources can include a user-friendly interface that allows easy query input and access to data context engine output; API integrations enable seamless connections with other organizational systems; and visualization tools support presenting the generated insights in digestible formats.

In operation, in a first embodiment, a query from an artificial intelligence (AI) agent is accessed. Based on the query, a dense context corresponding to the query is generated. The dense context is generated using a dense context generation service and enterprise data. The dense context is a programmatically-generated concise representation of data that provides context for language models to generate responses to queries. A dense context integrator and the dense context are used to generate an updated query of the query. A contextual response generation model and the updated query are used to generate a response. The response is communicated as a response to the query.

In a second embodiment, a query for a client associated with an artificial intelligence (AI) agent is communicated. Based on communicating the query, a response associated with the query is received. The response is generated based on a dense context associated with the query, an updated query associated with the dense context, and a dense context integrator of a contextual response generation model. The dense context is generated using a dense context generation service and enterprise data. The dense context is a programmatically-generated concise representation of data that provides context for language models to generate responses to queries. Display of the response to the query is caused.

In a third embodiment, enterprise data is accessed at a dense context generation service. The enterprise data and a plurality of dense context generation models of the dense context generation service are used to generate a dense context. The dense context is a programmatically-generated concise representation of data that provides context for language models to generate responses to queries. The dense context is communicated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A is a block diagram of an exemplary AI system including a dense context engine, in accordance with aspects of the technology described herein;

FIGS. 1B and 1C are dense context management schematics associated with a dense context management workflow of a dense context engine, in accordance with aspects of the technology described herein;

FIG. 2 is a flow diagram associated with an exemplary AI system including a dense context engine, in accordance with aspects of the technology described herein;

FIG. 3 provides a first exemplary method of providing dense context management using a dense context engine, in accordance with aspects of the technology described herein;

FIG. 4 provides a second exemplary method of providing dense context management using a dense context engine, in accordance with aspects of the technology described herein;

FIG. 5 provides a third exemplary method of providing dense context management using a dense context engine, in accordance with aspects of the technology described herein;

FIG. 6 provides a block diagram of an exemplary computing system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### OVERVIEW

An artificial intelligence (AI) system is a platform designed to perform tasks that typically require human intelligence, such as understanding language, recognizing patterns, and making decisions, often through learning from data. In particular, it can analyze large datasets to identify trends and provide insights that assist in strategic planning. An AI system can be a type of AI agent (e.g., such as an AI assistant, including AI assistants like Microsoft COPILOT, IBM Watson Assistant, Salesforce Einstein, OpenAI ChatGPT, and Rasa) that can be deployed in a computing environment to query. By way of illustration, an AI-based digital assistant uses artificial intelligence techniques like natural language processing and machine learning to understand and respond to user queries. When a user submits a question, the assistant processes the language to interpret the intent, retrieves relevant information from its knowledge base or external sources, and generates a coherent, contextually appropriate response in natural language. This enables the assistant to provide accurate and helpful information or perform tasks efficiently, mimicking human-like interaction.

Conventionally, AI systems are not configured with a comprehensive computing logic and infrastructure to efficiently and effectively respond to queries with dense context data having accurate (e.g., enterprise specific) context. Traditional fine-tuning and retrieval-augmented generation (RAG) methodologies for information retrieval in large language models (LLMs) exhibit significant limitations when it comes to interpreting user queries within the specific contexts of enterprise or corporate environments. One major challenge is the complexity of enterprise information, which can be vast and often redundant. Information on specific topics is frequently fragmented across various sources, making it difficult for models to synthesize coherent responses. This dispersal complicates the retrieval process, as the same content may be rephrased or presented in multiple formats across different documents and databases.

Moreover, the effectiveness of post-training processes depends on carefully designed methodologies that can integrate new knowledge while preserving the model's foundational language capabilities. Inadequate approaches can lead to catastrophic forgetting, where the model loses previously acquired knowledge, or result in a general degradation of performance across various tasks. This highlights the necessity for tailored approaches that maintain the integrity of the model while infusing it with specialized knowledge.

The precision with which queries are formulated also significantly influences the quality of the retrieved results. Queries that are inherently adversarial or designed to elicit negative responses can lead to similarly negative outcomes. Thus, using precise language that aligns with the intended context is crucial for effective information retrieval.

These limitations underscore the need for more context-aware retrieval methodologies that align model outputs with the unique requirements and operational frameworks of enterprises. While RAG demonstrates reasonable efficacy in extracting relevant information when provided with well-structured queries, its performance is often hampered by the quality of the underlying embedding models. Current embedding models tend to be smaller and lack the expressive power and flexibility necessary for effective query reinterpretation compared to LLMs. Furthermore, post-training can enhance reasoning and memorization capabilities within a specified tenant corpus. However, achieving this requires meticulously crafted post-training recipes that strike a balance between infusing specialized knowledge and retaining original language modeling capabilities. Existing literature, although somewhat lagging behind state-of-the-art advancements, supports the notion that flawed recipes can significantly impair model performance. Advancing the capabilities of LLMs in enterprise contexts necessitates innovative strategies that enhance context interpretation, optimize query formulation, and refine post-training methodologies to ensure robust and reliable performance. As such, a more comprehensive AI system—with an alternative basis for performing contextual response generation—can improve computing operations and interfaces for artificial intelligence systems.

### Description of Technical Solution

At a high level, contextual responses—using a dense context engine in an artificial intelligence system (i.e., a contextual response system)—enhance the understanding of user queries by leveraging dense context provided to a contextual response model. The contextual response model can specifically be a machine learning model with an extended context window that facilitates incorporating the dense context for responding to queries. A contextual response system can be an artificial intelligence (AI) response generation service that can leverage AI in various ways to provide enhanced functionality and provide users with advanced tools and features to process queries and produce contextually accurate responses based on processing the queries. The contextual response system can support integrating a dense context with user queries to generate contextually accurate responses to user queries, including context associated with an organization context and personal context associated with the user sending the query. The contextual response system can be a contextual response system that leverages a dense context integrator and AI tools, such as machine learning models, large language models (LLMs), and retrieval-augmented generated (RAG) models, in various ways to provide enhanced functionality and provide users with contextually accurate responses to queries.

By way of context, LLMs have transformed the landscape of natural language processing by enabling sophisticated reasoning over extensive corpora and complex tasks. Traditionally, two primary methodologies have been employed for this purpose: Retrieval-Augmented Generation (RAG) and fine-tuning. However, recent advancements in LLM architectures (e.g., extension of context windows) can support a technical solution focused on optimizing the use of a contextual framework (e.g., a dense context engine). The dense context engine can include a dense context generation engine for dense context generation and a contextual response generation engine for contextual response generation. The process of dense context generation involves the generation of dense context via the dense context generation engine (e.g., dense context generation service or dense context generation pipeline) using enterprise data, the dense context can be specifically designed for LLM-based document understanding. Dense context generation serves as a framework for extracting key findings and producing comprehensive community reports across various documents. For each document processed, a summary of extracted information is collated to form a dense context that encapsulates the essential themes and data points of the entire document corpus.

This dense context generation engine synthesizes significant organizational knowledge and user-specific insights, effectively condensing vast amounts of information into a coherent representation. Techniques such as natural language summarization and entity recognition are employed to distill pertinent details while filtering out extraneous “filler” language often present in human communications. The outcome is a high-level, human-like summary that enhances the relevance and interpretability of user queries by providing LLMs with critical context.

Once the dense context is generated, it is strategically utilized in multiple stages of a contextual response generation (e.g., contextual response generation service or contextual response generation pipeline). Initially, user queries are enhanced by integrating the dense context, which enriches the queries with contextual information pertinent to the user's specific needs and the organizational environment. This enhancement facilitates a deeper understanding of the user's intent, allowing the model to reframe queries in a manner that makes it easier to locate hard-to-find answers.

In one embodiment, in the final stages of contextual response generation, the dense context is combined with data retrieved through a RAG methodology. By incorporating the contextual information derived from the dense context, a contextual response generation model can generate responses that are not only accurate but also contextually relevant. This two-tiered approach significantly improves the quality of the responses, providing users with answers that are more nuanced and aligned with their inquiries.

By way of illustration, the contextual response generation process begins with a user request, initiating the interaction. For instance, let's say a user from a software team submits a user query: “What are the recent trends in software development methodologies?” The first step involves determining whether the query is a first query (e.g., a first query in a chat context). If the query is not a first query, the query can be rewritten with chat context, then the process moves to the next step (i.e., dynamically selecting a dense context for the query). However, if the query is a first query, the process moves directly to dynamically selecting the relevant dense context for the query. For example, this is done by identifying the top 100 nearest neighbors based on semantic similarity to the user's query. The selection is achieved through advanced techniques that compare the user's query text against a complete dense context blob, ensuring that the retrieved information is highly relevant to the user's needs.

Once the dense context has been identified, the next step involves amplifying the user's query (e.g., generating an updated query via a dense context integrator) using the insights derived from this dense context. For example, if the dense context includes information about popular frameworks like Agile, DevOps practices, and the rise of remote collaboration tools, the system enriches the original query to something like: “Can you summarize the recent trends in software development methodologies, including Agile practices and the impact of remote collaboration tools?”

Following this, query transformation (e.g., a variation or partition generator prompt via the dense context integrator) is employed, which outputs three distinct variations of the amplified query (i.e., an updated query). The variation or partitions generated from the query transformation can be referred to as transformed updated queries. In this case, the variations might be: (1) “What are the latest developments in Agile software development?”; (2) “How are DevOps practices evolving in modern software teams?”; and (3) “What tools are becoming essential for remote collaboration in software development?”

At this stage, by way of example, the dense context engine now has these three newly generated queries in addition to the original one. The next step involves applying Retrieval-Augmented Generation (RAG) to all four queries, including the three variations and the original user query. RAG leverages a substrate document endpoint to collect contextually relevant information, retrieving the top document for each of the four queries. For example, it might find recent articles and reports that detail the latest trends and best practices in software development.

After retrieving the necessary documents, the dense context engine communicates the RAG data alongside the user's original query, setting the stage for the next phase. This could involve presenting a summary of the documents retrieved, such as “Recent trends in software development methodologies include the widespread adoption of Agile frameworks, the increasing importance of DevOps practices, and the growing reliance on remote collaboration tools like Slack and Jira.”

The contextual response generator prompt is then utilized to synthesize the collected information into a coherent response. This might result in a comprehensive answer like: “Recent trends in software development methodologies indicate a significant shift towards Agile practices, which emphasize iterative development and collaboration. Additionally, DevOps practices are evolving to enhance communication between development and operations teams, focusing on automation and continuous integration. The rise of remote work has also led to the increased use of collaboration tools such as Slack and Jira, enabling software teams to maintain productivity and effective communication regardless of physical location.”

Finally, the dense context engine generates this detailed response, effectively addressing the user's initial request with a well-informed and contextually relevant answer. This structured approach not only enhances the accuracy of the information provided but also ensures that the user receives insights tailored to their specific inquiry.

In this way, the dense context approach addresses several limitations inherent in current methodologies. For instance, while RAG is effective at retrieving information when provided with precise queries, it can struggle in scenarios where adversarial responses or negative framing exist. Furthermore, the effectiveness of RAG is contingent upon the quality of the embedding models used for retrieval, which often lack the expressive power and adaptability of LLMs.

In contrast, fine-tuning, although powerful, demands substantial computational resources and meticulous crafting of training recipes. These recipes must maintain the core language modeling capabilities of the LLM while infusing new knowledge; any missteps can lead to catastrophic forgetting or degradation of model performance. Dense context generation, on the other hand, allows for agile updates to the contextual information without the overhead associated with traditional fine-tuning.

The dense context engine represents a significant advancement in enhancing the capabilities of LLMs for interpreting user queries and generating contextually relevant responses. By synthesizing extensive amounts of information into coherent, high-level summaries, this approach enables LLMs to process user requests with greater accuracy and relevance. Furthermore, by facilitating more frequent updates to the dense context, the methodology offers a resource-efficient alternative to fine-tuning, thereby enhancing enterprise content understanding.

Advantageously, the embodiments of the present technical solution include several inventive features (e.g., operations, systems, engines, and components) associated with an artificial intelligence system having a dense context engine. The dense context engine supports identifying, curating, and synthesizing dense context, and further supports generating a contextually accurate response to queries using the dense context via the contextual response generation engine. The contextual response generation engine can support integrating dense context with user queries to generate contextually accurate responses to user queries, including context associated with an enterprise and personal context associated with the user sending the query. In particular, the contextual response generation engine may leverage AI in various ways to provide enhanced functionality and provide users with contextually accurate responses to queries that are specific to the user and/or the enterprise, including subgroups within the enterprise. For example, a user can provide a query to the contextual response system client for the dense context engine to generate a response, and the dense context engine, utilizing a contextual response generation model, generates and utilizes dense context that is unique to an enterprise and the user to generate a contextually accurate response to the query. Hence the response that is generated by the dense context engine for the user query is much better (e.g., more contextually accurate) than if the query was just processed using traditional methods.

### Example Systems and Resources

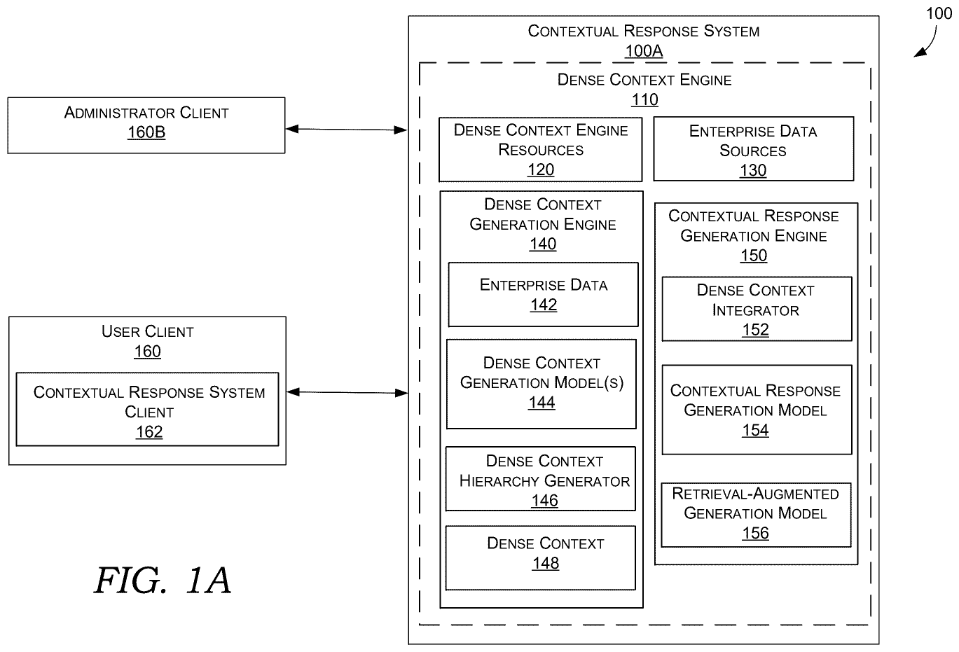

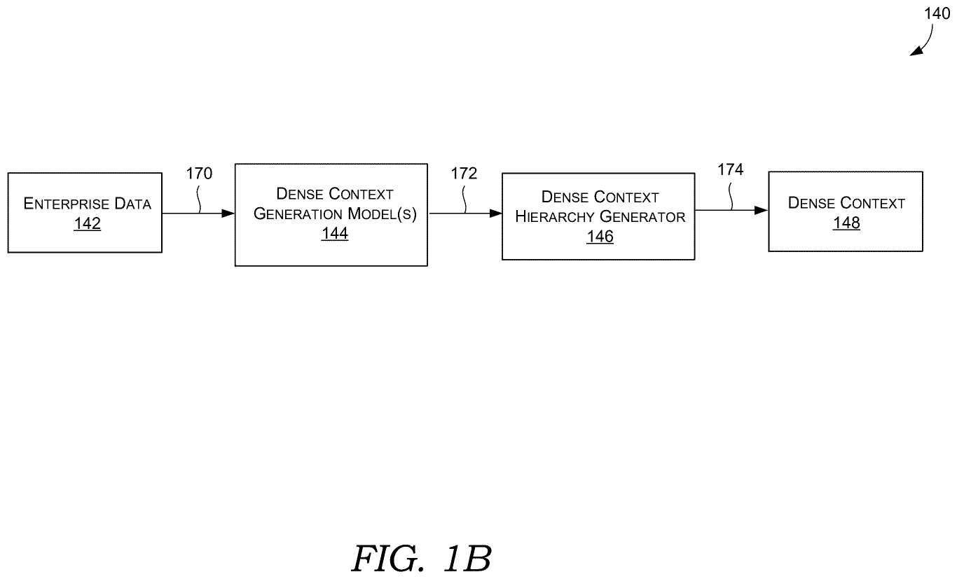

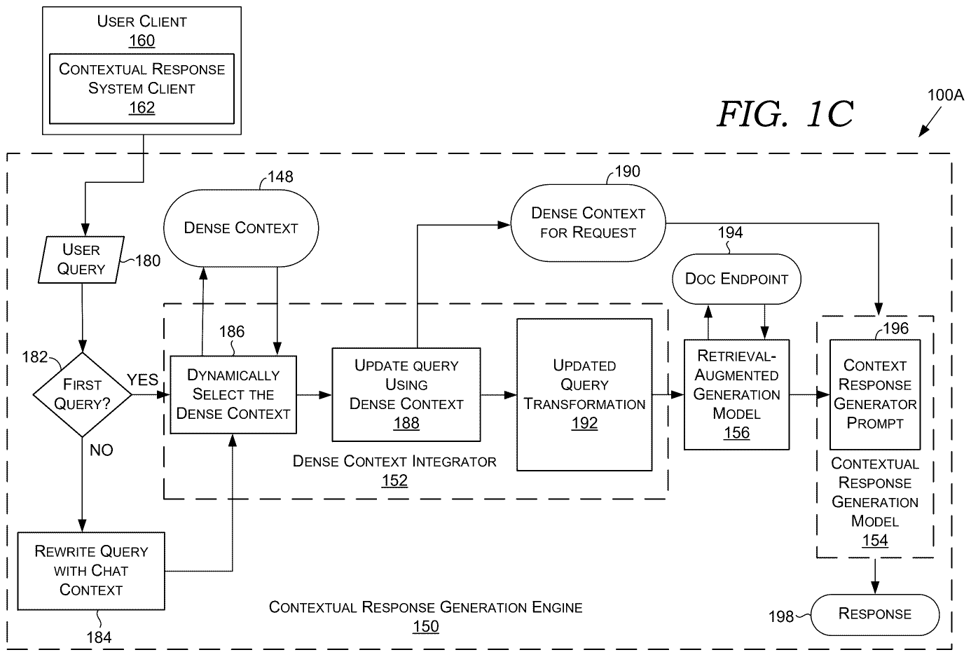

Aspects of the technical solution can be described by way of examples and with reference to FIGS. 1A-1B . FIG. 1A illustrates a cloud computing environment (system) 100, contextual response system 100A; dense context engine 110, dense context engine resources 120, enterprise data sources 130; dense context generation engine 110, including enterprise data 142, dense context generation model 144, dense context hierarchy generator 146, and dense context 148; contextual response generation engine 150, including dense context integrator 152, contextual response generation model 154, and retrieval-augmented generation model 156; user client 160, including contextual response system client 162; and administrator client 160B.

The cloud computing system 100 provides a computing environment for implementing contextual response system 100A (e.g., artificial intelligence system). Contextual response system 100A can analyze large datasets and provide responses to queries. The contextual response system 100A supports generating answers to queries by retrieving relevant information from its knowledge base and using natural language processing to synthesize and articulate coherent, contextually appropriate responses. User client 160 engages with the contextual response system 100A—via contextual response system client 162, to primarily to retrieve information, submit specific queries, and receive detailed responses, often using features like search or document retrieval. For example, the user client 160 can interact with dense context-related content through a user-friendly interface, which may include access to responses generated based on dense contexts purposes.

Administrator client 160B handles the backend tasks, such as managing dense context generation, configuring the retrieval-augmented generation (RAG) system, and managing employing the contextual response generation model 154. Administrator client 160B can support data ingestion, including uploading new knowledge base documents, monitoring system performance, and adjusting parameters for dense context generation, ensuring the model's output aligns with current requirements.

Dense context engine 110 supports document understanding and responds to user queries in organizational settings. Dense context engine 110 provides dense context management using dense context resources 120 (e.g., data, operations, and interfaces). At its core, the dense context engine 110 relies on a comprehensive repository of documents, reports, and datasets relevant to the organization. This document corpus serves as the foundational input for the dense context generation engine 140, enabling it to extract key findings and insights from a diverse range of sources. Accompanying this is contextual metadata, which includes information about the documents such as authorship, publication date, subject matter, and relevance tags. This metadata enriches the context generated, ensuring that the output is tailored to specific organizational needs. Additionally, user profiles that contain data about users—such as roles, preferences, past interactions, and specific query histories—allow for personalization, enhancing the relevance of the responses generated.

The operations of the dense context engine 110 encompass both dense context generation and contextual response generation. The dense context generation operation processes prompts through the dense context generation engine 140, utilizing natural language processing techniques to extract salient information and produce dense contexts summarizing key findings from the document corpus. This involves information extraction to identify and pull critical data points, trends, and insights from documents, as well as summarization algorithms that generate concise summaries encapsulating the essential information needed for comprehensive reports.

On the other hand, contextual response generation leverages the dense context to enhance user queries by integrating relevant contextual information through contextual response generation engine 150. This includes query enrichment, where user queries are augmented with extracted contextual data to ensure that contextual response generation model 154 and retrieval-augmented generation model 156 can generate responses that are both accurate and aligned with the organizational environment. The operation culminates in response generation, where the contextual response generation model 154 uses its capabilities to produce context-aware answers, ensuring that responses reflect not only factual accuracy but also the user's specific needs.

To facilitate interaction with users, the dense context engine 110 incorporates a user-friendly interface that allows for easy query input and access to generated responses. This interface also displays contextual data and insights extracted during the dense context generation process, promoting user engagement. Furthermore, API integrations allow for seamless connections with other organizational systems, such as knowledge management systems, enabling the dense context engine 110 to pull relevant data dynamically and push generated insights back into workflows. Visualization tools present the generated dense contexts and responses in easily digestible formats, such as dashboards or visual reports, helping users quickly comprehend complex information and derive actionable insights.

Dense context generation engine 140 provides a service or pipeline that is integrated into an enterprise computing environment associated with a plurality of enterprise data sources (e.g., enterprise data sources 130) comprising the enterprise data. The dense context generation service is a contextual summary service that programmatically transforms the enterprise data into dense contexts. Dense context generation engine 140 acts as the entry point for information including gathering data from a wide range of enterprise data sources 130. Dense context generation can employ Named Entity Recognition (NER) algorithms to identify and classify key entities within the text, such as people, organizations, locations, and concepts. By leveraging pre-trained models the dense context generation engine 140 recognizes entities.

Dense context generation engine 140 also processes the enterprise data through large language models (LLM) (e.g., dense context generation model(s) 144). This phase involves passing the organized input through the LLM, which generates concise and coherent summaries. The LLM's capabilities enable it to synthesize information from multiple sources, producing a narrative that captures the essence of the input data while maintaining technical accuracy. Dense context generation engine 140 analyzes the relationships among the identified entities and topics to construct a structured hierarchy. Utilizing techniques (e.g., dense context hierarchy generator 146) such as topic modeling and clustering algorithms, it identifies main themes and subtopics within the data. Dense context generation engine 140 can provide the dense context to the contextual response generation engine 150 to generate responses.

Contextual response generation engine 150 can generate responses specifically via the dense context integrator 152. Dense context integrator 152 is a mechanism designed to enhance the user's query by amplifying it with insights derived from dense context. An updated query is generated, and the updated query incorporates relevant knowledge and nuances, allowing for a more comprehensive search. To implement this, a variation or partition generator prompt is utilized, producing three distinct variations of the updated query. This approach ensures a broader exploration of relevant content and maximizes the retrieval potential. In this way, dense context integrator 152 supports integrating dense context with the query to generate the updated query, the dense context integrator 152 is configured to transform the updated query into one or more additional queries.

Optionally, Retrieval-Augmented Generation (RAG) is applied to all four queries: the original user query and the three variations. This process enables the system to leverage a diverse set of queries, enhancing the retrieval of relevant documents and ultimately leading to richer and more contextually informed responses. For example, a RAG model 156 uses at least the updated query to retrieve RAG data (e.g., via a RAG document repository) including one or more documents from a RAG document repository and communicates the query and the RAG data to the contextual response generation model 154 to cause generation of the response.

Contextual response generator model 154 is integrated in an enterprise computing environment to employ two or more of the following: the query, the updated query, a transformed updated query, RAG data, and the dense context to generate the response. Operationally, the dense context engine 110 receives a user query from the user client 160 (e.g., computing device of an enterprise) via the contextual response system client 162 (e.g., a graphical user interface (GPU) on the computing device). The dense context engine 110 retrieves dense context 148 generated by the dense context generation engine 140. The dense context engine 110 includes the contextual response generation engine (e.g., contextual response generation engine 150 and contextual response generation model 154) that utilizes the dense context 148 to generate contextually accurate responses to user queries. The contextually accurate responses are sent from the dense context engine 110 to the user client 160 in response to the user query for display. It is contemplated that the user client 160 (e.g., an interface) is designed to create visual or interactive elements that relate to a response. The response can include the dense context or segments of the dense context (e.g., key pieces of relevant information from a compact representation of the dense context) to be presented on the interface in a way that enhances usability and understanding.

Dense context engine 110 can support an enterprise context mode, a user context mode, and a combination mode. Operationally, in the enterprise context mode, the dense context is based on information specific to the organization, drawing from internal knowledge bases, company policies, and industry standards. This allows the contextual response generation model 154 to provide answers that align with the organization's goals, terminology, and operational guidelines. The responses are tailored to reflect the enterprise context (e.g., company's values and procedures).

Conversely, in user context mode, the focus shifts to the individual user. The dense context is based on data about the user's preferences, history, and specific interactions to offer personalized responses. This user context mode emphasizes customization, adapting to the user's past interactions and interests, creating a dynamic context that evolves with ongoing exchanges. The goal is to provide insights that cater specifically to the user's needs rather than organizational mandates.

In combination mode, the dense context engine 110 seamlessly integrates both enterprise and user contexts to deliver a comprehensive response. This mode leverages the authority of organizational knowledge while simultaneously tailoring answers to the individual's preferences. The result is balanced responses that are relevant not only to the organization but also to the individual, ensuring that the information provided is both accurate and applicable. The contextual response generation model 154 can adapt its responses based on feedback from both the organization and the user, continually refining its understanding of each context.

Contextual response generation engine 150 may rely on the hierarchical structure in the dense context to support the different model. The hierarchical structure in dense context effectively supports the different modes—enterprise context, user context, and combination mode—by organizing information in a way that allows for flexible and efficient access to relevant data. In enterprise context mode, a hierarchical structure enables the contextual response generation engine 150 to quickly retrieve information based on various organizational layers, such as departments, projects, or categories. This organization ensures that the responses are aligned with company policies and procedures while maintaining a clear overview of the organizational framework.

In user context mode, the hierarchical structure allows for personalization by organizing data according to user preferences, roles, and past interactions. This facilitates tailored responses, as the contextual response generation engine 150 can draw from relevant subcategories that match the individual's history and interests.

When operating in combination mode, the hierarchical structure serves as a bridge between enterprise and user contexts. It allows the contextual response generation engine 150 to efficiently navigate both organizational knowledge and individual user data, ensuring that responses are comprehensive and contextually appropriate. By integrating insights from both levels, the contextual response generation engine 150 can provide answers that are not only accurate but also relevant to the specific needs of the user within the broader organizational framework.

With reference to FIG. 1B, FIG. 1B illustrates a dense context generation engine 140 of a dense context engine 110 including enterprise data 142, dense contextual generation machine learning model 144, dense context hierarchy generator 146, and dense context 148.

Dense context generation engine 140 provides for generating dense context (i.e., dense context 148) and further facilitates generating contextually accurate responses based on the dense context. The dense context generation engine 140 can operate as a service that condenses large volumes of data (e.g., enterprise data 142 associated with the enterprise data sources 130) into high-level, human-like summaries using machine learning models within an efficient data pipeline. The process begins at step 170 with data ingestion from various sources (i.e., enterprise data sources 130), followed by employing machine learning models (e.g., a dense context generation model(s) 144 and a dense context hierarchy generator 146) for extractive and abstractive summarization techniques, and leads to the generation of concise summaries that retain core messages and relevant details into dense context 148.

The dense context generation engine 140 processes the enterprise data 142 from the enterprise data resources 130 to generate dense context 148. The enterprise data 142 comprises knowledge about an enterprise, such as an organization, company, corporation, and similar entities. The enterprise data sources 130 includes documents associated with the enterprise, such as PowerPoints, emails, Word documents, and any other documents that can be associated with the enterprise. Accordingly, the enterprise data sources 130 comprises a large corpus of content, and the content can relate to the enterprise as a whole, to groups within the enterprise, to teams within the groups, and/or to individuals on the teams. All of the documents associated with the enterprise that comprises the enterprise data sources 130 is subject to permissions. For example, if there was private information that only some employees of the enterprise had access to, that information would still constitute enterprise data sources 130, but that information would only be accessible as dense context 148 if a user submitting the user query has permission to access the information associated with the enterprise data sources 130, as explained in more detail below. In general, the enterprise data 142 includes the data associated with the enterprise data resources 130. The enterprise data 142 can be stored in a data store for retrieval by the dense context generation engine 140 to process and to be used to generate dense context 148.

The dense context generation engine 140 retrieves 170 the enterprise data 142, processes the document text within the enterprise data 142, and utilizes machine learning models to extract findings from the dense context 142. For example, the machine learning model may be an LLM that utilizes LLM prompts to extract findings from the enterprise data 142. One or more LLM prompts may be utilized on the list of findings to generate dense context 148 around the findings. As such, the dense context generation engine 140 distills the enterprise data 142 into dense context 148 (e.g., extracted information). In some examples, the dense context 148 can be text files. The dense context 148 may contain titles, summaries, and weights to the information that is discovered. For example, a summary of the extracted findings from may carry more weight than a title. The dense context 148 may be organized into groupings within a hierarchy. The dense context generation engine 140 generates dense context 148 during an offline process. The offline process may be performed iteratively at a configurable interval (e.g., hourly, daily, weekly, etc.).

The dense context generation engine 140 can include the dense context generation model(s) 144. Generally, the dense context generation model(s) 144 is one or more LLMs, but any machine learning model capable of facilitating the operations of the dense context generation model(s) 144 is contemplated within this disclosure. The dense context generation model(s) 144 process the enterprise data 142 to extract out (e.g., generally using an LLM) the most relevant information from the enterprise data 142. The enterprise data 142 likely includes filler language, which is portions of a corpus (e.g., the enterprise data resources 130) that do not contribute to the core message of a document and can be removed without sacrificing the essence of the document, which is why the dense context generation model(s) 144 distills the enterprise data 142 into the most relevant information associated with the enterprise data 142. The dense context generation model(s) 144 extracts entity specific information and identifies entities present in the enterprise data 142, such as whether one document of the enterprise data 142 pertains to the enterprise as a whole or a person associated with the enterprise (e.g., extracts the essence of the document). Effectively, all of the enterprise data 142 is run against a prompt (e.g., an LLM prompt), which prompts the dense context generation model(s) 144 to pull out the relevant information associated with the enterprise data 142.

In some embodiments, the dense context generation model(s) 144 utilizes one or more subsequent prompts (e.g., one or more LLM calls) to create a summarization of all the entities that are present in each document of the enterprise data 142, and these summaries become the dense context 148 for each particular document. The dense context generation model(s) 144 makes inferences across the documents, such as inferences related to the enterprise as a whole or individuals within the enterprise.

In some embodiments, the dense context generation model(s) 144 makes a comparison between documents associated with the enterprise data 142 to determine whether there are any new documents (e.g., new documents uploaded as enterprise data sources 130) in which to use to update the dense context 148. The dense context generation model(s) 144 uses information extraction and compression patterns that are in a cyclic code before a certain degree of compression can be achieved, then the compressed information is applied to create the dense context 148 per document. The dense context 148 per document is grouped together by the dense context hierarchy generator 146. As such, the dense context 148 is not formed by a single machine learning prompt (e.g., a single LLM call), but rather multiple machine learning calls that include particular prompts to pull out information, identify entities, and describe the entities are used by the dense context generation engine 140 to generate the dense context 148.

The dense context hierarchy generator 146 determines patterns related to specific information (e.g., entity level, group level, individual level, etc.) within the dense context 148 generated by the dense context generation model(s) 144 (e.g., represented with an arrow 172). In some embodiments, the dense context hierarchy generator 146 infers that enterprise data 142 is associated with the entity as a whole, associated with groups within the enterprise (e.g., different departments of an organization), associated with teams within the groups (e.g., a billing team within the financial group of an organization), and associated with individuals within the enterprise (e.g., a biller on the billing team within the financial group of an organization). As such, different levels of dense context 148 are created for each level within an enterprise, including the enterprise as a whole, groups within the enterprise, teams within the groups, employees on the teams, and any other hierarchical organization of an enterprise. Accordingly, the dense context hierarchy generator 140 of dense context generation engine 140 is a contextual information compression approach that creates the dense context 148 (e.g., represented with an arrow 174).

In some embodiments, the hierarchy of dense context 148 is pre-determined by users before the enterprise data resources 130 associated with each level of the hierarchy within the enterprise are processed as enterprise data 142 by the dense context generation model(s) 144 to generate the dense context 148. The dense context 148 does not need to be stored in a hierarchy form, but the contextual response system 100A may be aware of the hierarchy. By generating the dense context 148 in a hierarchical format, the hierarchical format can indicate broader and narrower concepts within the enterprise and within the dense context 148, enriching the dense context 148 associated with the enterprise data 142.

The format of the dense context 148 may be human readable natural language (e.g., a text file, which can be the standard formatting of the dense context 148). In some embodiments, the dense context 148 may be compressed in terms of token count. In these embodiments, the dense context 148 may not be in a human readable format. In another embodiment, the dense context 148 could be compressed into a vector, where the dense context 148 would be represented as numbers, compressing the dense context 148 even further. In another embodiment, the dense context 148 could be compressed by dropping non-useable tokens (e.g., still natural language, but not necessarily in a natural language format). Overall, the enterprise data 142 is processed by the dense context generation engine 140 and distilled (e.g., compressed) into dense context 148 in such a way to help the contextual response generation engine 150 interpret user requests and generate contextually accurate responses to user queries using the dense context 148.

With reference now to FIG. 1C, FIG. 1C illustrates an example contextual response system 100A utilizing dense context 148 to process a user query (e.g., user query 180) and to generate contextually accurate responses based on the dense context 148 and the user query. The contextual response system 100A can include the user client 160 and the contextual response system client 162 that facilitate sending user queries to the dense context engine 110 and receiving contextually accurate responses from the dense context engine 110.

The dense context engine 110 includes the contextual response generation engine 150. The contextual response generation engine 150 is a separate service as compared to the dense context generation engine 140. For example, instead of generating dense context 148, the contextual response generation engine 150 utilizes the dense context 148 to generate contextually accurate responses (e.g., response 198) to user queries. The contextual response generation engine 150 receives a user query from the user client 160 via the contextual response system client 162. After receiving the user query, the dense context engine 110 processes the user query using techniques like natural language processing. The contextual response generation engine 150 retrieves the dense context 148 generated by the dense context generation engine 140. Utilizing a dense context integrator 152, the contextual response generation engine 150 amplifies the user query with the dense context 148 by combining the user query and the dense context 148 (e.g., including the hierarchy of the dense context 148) into a single prompt. The contextual response generation engine 150 uses machine learning models (e.g., a contextual response generation model 154 and/or a RAG model 156, as well as other machine learning models and techniques) to process the amplified user query and generate contextually accurate responses to the user query for display on the user client 160.

The contextual response generation engine 150 initially determines whether the user query 180 is a first query 182. In other words, the contextual response generation engine 150 determines whether the user query 180 is the first query that this particular user has submitted to the dense context engine 110. If the user query 180 is not the first query 182 (e.g., the same user has previously submitted a query to the dense context engine 110), then the contextual response generation engine 150 utilizes a machine learning model call (e.g., an LLM prompt) to rewrite the user query 180 with chat context 184. By rewriting the user query 180 with chat context 184, the context associated with all of the interactions between the user and the contextual response system 100A is utilized to better interpret the user query 180. For example, if the user has previously submitted queries regarding the financial department of an enterprise, the user query 180 may be rewritten to include the context related to those financial department queries.

When the user query 180 is rewritten to include the chat context 184, or if the user query 180 is the first query 182, the contextual response generation engine 150 provides a dense context integrator 152 to process the user query 180. The dense context integrator 152 enables dynamically selecting the dense context (i.e., dynamically select the dense context 186), updating the user query 180 to an amplified query (or updated query) using the dense context (i.e., update query using dense context 188) and transforming the amplified query (i.e., updated query transformation 192).

Operationally, the dense context integrator 152 may dynamically select the dense context 186. By dynamically selecting the dense content 186, the dense context integrator 152 utilizes the user query 180 to select the most relevant dense context 148 that pertains to the user query 180. For example, the contextual response generation engine 150 may use the text of the user query 180 to retrieve the dense context 148 that relates to the text of the user query 180. Alternatively, or in addition to, the contextual response generation engine 150 may use the identity of the user sending the user query 180 to retrieve the dense context 148 that pertains to that specific user.

In an embodiment, the contextual response generation engine 150 utilizes a top 100 nearest neighbors method to identify the 100 closest dense context 142 based on the user query 180 and the identity of the user sending the user query 180. In this way, the contextual response generation engine 150 retrieves the dense context 148 that is relevant in responding to the user query 180. The dense context 148 that is retrieved and that is relevant in responding to the user query 180 can be communicated as dense context for request 190, which is used by one or more machine learning model calls of the contextual response generation engine 150 (e.g., the contextual response generation model 154 and/or a context response generator prompt 192) to generate the contextually accurate response 198.

The dense context 148 that is retrieved by the contextual response generation engine 150 is subject to permissions. For example, if some of the dense context 148 contained private information that only some individuals within the enterprise had access to, then that specific dense context 148 would not be retrieved by the contextual response generation engine 150 (e.g., would not become dense context for request 190) unless the user submitting the user query 180 had permission to access that dense context 148 in the first place. Accordingly, the dense context 148 may only include information that the requesting user has permission (e.g., is not restricted) to access.

The dense context 148 is used by the dense context integrator 152 of the contextual response generation engine 150 to amplify the user query 180. In other words, the dense context integrator 152 integrates the dense context 148 and the user query 180 into a single amplified query (e.g., updated query)—such as part of a single prompt (e.g., as a static part of the prompt)—for processing by the contextual response generation engine 150. The dense context integrator 152 utilizes the dense context for the request 190 and the user query 180 to generate the single amplified query within the constraints of a context window associated with the contextual response generator model 154 and/or context response generator prompt 196 (e.g., associated with the contextual response generation model 154). The size of the context window can vary, but the context windows are generally large enough to include the amplified query that comprises the dense context 148 and the user query 180. The context window can support the amplified query for processing by the contextual response generation model 154.

In an embodiment, the contextual response generation model 154 utilizes the amplified query to generate a contextually accurate response 198 to the user query 180. For example, the contextual response generation model 154 may utilize machine learning calls (e.g., one or more LLM prompts) on the amplified query to generate the context response generator prompt 196. The context response generator prompt 196 may be used by the contextual response generation model 154 to generate the contextually accurate response 198. Accordingly, in some embodiments, the contextual response generation model 154 requires no other information besides the amplified query to generate the contextually accurate response 198. As such, in these examples, there is no need for the RAG model 156.

In an embodiment, the dense context integrator 152 partitions (e.g., via updated query transformation 192) the amplified query by utilizing machine learning calls (e.g., one or more LLM prompts). For example, by utilizing LLM prompt, the amplified query in the context window may be partitioned into one or more or more queries, such as four separate queries (e.g., three queries related to the dense context for request 190 and one query for the user's original query, the user query 180). In this example, the partitions of the amplified query may be processed by the RAG model 156 to generate the context response generator prompt 196.

In an embodiment, the RAG model 156 runs RAG on the partitions of the amplified query in the context window to collect all relevant context associated with the amplified query to generate the context response generator prompt 196. Here, the partitions of the amplified query in the context window is the information that the RAG model 156 has access to, allowing the RAG model 156 to focus on pertinent details associated with the user query 180 while ignoring irrelevant data, thus enhancing the quality of the contextually accurate response 198 that is ultimately generated. By processing the partitions of the amplified query in the context window, the RAG model 156 can use the partitions to give context to the user query 180. For example, the RAG model 156 may run RAG on the four partitions in the previous example. In running RAG on the partitions of the amplified query, the RAG model 156 utilizes a doc endpoint 194 (e.g., a substrate endpoint). The doc endpoint 194 retrieves and/or generates a top document from the dense context for request 190 for each of the partitions, which becomes the RAG data associated with the RAG model 156. The RAG data informs the contextual response generation engine 150 about the context associated with the user query 180 so that the contextual response generation model 154 can better interpret the user query 180. The RAG data and the user's original prompt are combined to form the contextual response generator prompt 196.

The contextual response generation engine 150 processes the contextual response generator prompt 196 to generate the contextually accurate response 198. For example, the contextual response generation engine 150 (e.g., via the contextual response generation model 154) utilizes a machine learning call to process the contextual response generator prompt 196. By containing all of the relevant information associated with the user query 180, including the RAG data and the user query 180 itself, the contextual response generation engine 150 is able to generate the contextually accurate response 198 in response to the user query 180. After the contextually accurate response 198 is generated, the dense context engine 110 sends the contextually accurate response 198 to the user query 180 to be displayed on the local client 190.

In this way, the dense context engine 110 improves the experience of the contextual response system client 162 by enhancing reliability (e.g., the contextual response system client 162 providing more accurate output to user queries) and reducing error rate (e.g., reduced likelihood of responses that lack context regarding the user query). To achieve these improvements, the dense context engine 110 utilizes dense context 148 that is generated in an offline process to add enterprise-specific context to user queries in responding to queries. For example, if the user query was, “what was the financial team's latest project,” the dense context data 148 would be used by the contextual response generation engine 150 to inform the contextual response generation engine 150 about the financial team within an enterprise, including information associated with the financial team as well as individuals who are on the team. In this example, the contextual response generation engine 150 may retrieve dense context for the request 190 that includes the financial team's latest project, and this information may be used by the contextual response generation engine 150 to generate RAG data. Here, the RAG data would be used by the contextual response generation engine 150 in addition to the user query 180 to generate and cause display of the contextually accurate response 198 to the user query 180. Accordingly, the dense context engine 110 effectively processes and responds to user queries.

In one example embodiment, a contextual response system client can operate on a local client (e.g., a client device), initiating the interaction with the user. After receiving a query, the contextual response system client locally processes the query using techniques like natural language processing. Then the contextual response system client forwards the processed query to a dense context engine hosted on a remote server or cloud platform. The dense context engine is equipped with sophisticated algorithms and machine learning models for generating a response to the query. In particular, the dense context engine makes calls to a dense context service (i.e., dense context generation engine) specialized in particular tasks or data sources associated with the generation of dense context. For example, the dense context service condenses large volumes of data into high-level, human-like summaries using machine learning models within an efficient data pipeline. The dense context service complements a contextual response service by providing necessary input or processing to enhance response generation. Through application programming interfaces (APIs) or web services, the dense context service communicates with the contextual response service, exchanging information as needed to produce contextually accurate response to our queries

Once the contextual response service has all of the required input (e.g., the dense context received from the dense context service), the contextual response service generates a comprehensive response to the user's query. This response is then communicated back to the contextual response system client on a client device. Finally, the contextual response system client presents the response to the user in a suitable format, such as spoken language, text, or visual display. This architecture efficiently combines the dense context generated by the dense context service with the advanced capabilities of the contextual response service, ensuring effective processing of user queries.

By way of example, a TechSolutions, a company with a vast internal knowledge base, maintains extensive documentation on its products, services, customer interactions, and technical guides. To create a comprehensive dense context, a large corpus of documents is collected, encompassing product manuals, service protocols, and customer feedback reports.

Using the dense context generation engine 140, key findings from each document are extracted. For instance, the product manual for the SmartWidget 3000 details its features, specifications, and troubleshooting steps, while a customer feedback report summarizes common issues and solutions encountered over the past year. These extracted findings are then condensed into a coherent dense context. An example of this summary could be: “The SmartWidget 3000 features advanced AI capabilities for user customization and is supported by a troubleshooting guide that addresses common issues such as connectivity problems and battery life. Recent customer feedback highlights satisfaction with the product's usability but notes concerns regarding its initial setup process.” This dense context provides a unified overview of relevant knowledge about the SmartWidget 3000, synthesizing insights from both product documentation and customer experiences.

In a separate scenario, a customer reaches out for assistance with a technical issue related to their SmartWidget 3000, posing the question, “I'm having trouble setting up my SmartWidget 3000. What should I do?” To respond effectively, the original query is enhanced using the previously generated dense context. The enhanced query becomes: “User is having trouble setting up their SmartWidget 3000, which has advanced AI capabilities for customization. Recent feedback indicates common setup issues.”

The LLM processes this enhanced query alongside the dense context to generate a relevant response. It might state: “To assist with the setup of your SmartWidget 3000, please ensure that it is charged and within range of your Wi-Fi network. Many users have reported initial setup challenges, particularly with connectivity. If issues persist, refer to the troubleshooting guide, which provides step-by-step instructions for resolving common setup problems. If you continue to experience difficulties, please let us know, and we can provide further assistance.”

This response not only addresses the user's immediate concern but also incorporates contextual knowledge about common issues and solutions, enhancing its informativeness and relevance. As such the dense context engine can support dense context generation to provide a rich, summarized understanding of information, while contextual response generation leverages that understanding to produce targeted, useful replies to user inquiries.

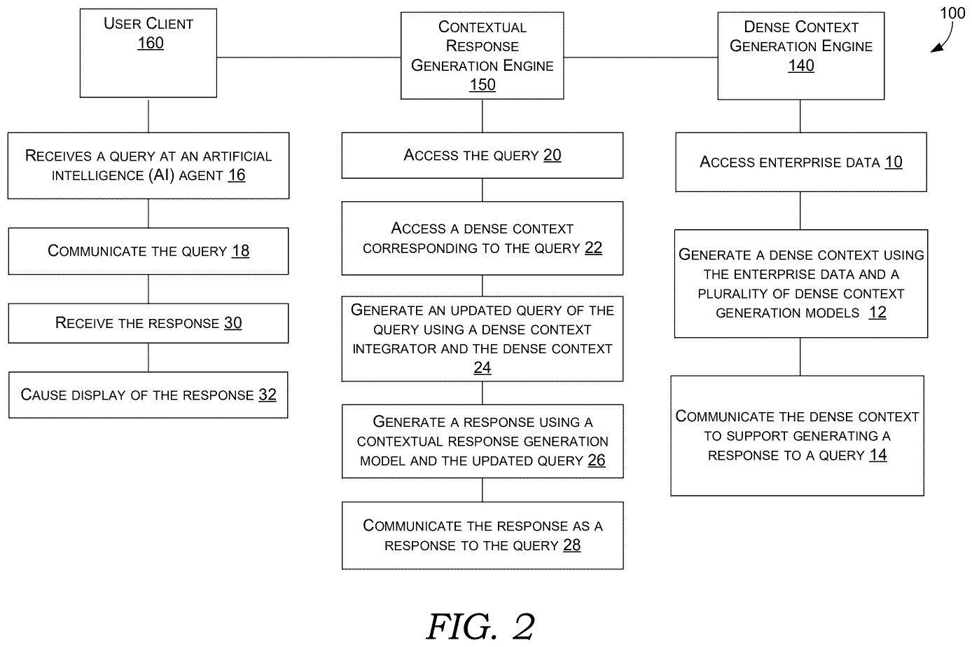

With reference to FIG. 2, FIG. 2 illustrates a cloud computing system 100 having user client 160, contextual response generation engine 150, and dense context generation engine 140. At block 10, the dense context generation engine 140 access enterprises data; at block 12, generates a dense context using the enterprise data and a plurality of dense context generation models; at block 14, communicates the dense context to support generating a response to a query.

At block 16, the user client 160 receives a query at an artificial intelligence agent; and at block 18, communicates the query. At block 20, the contextual response generation engine 150 accesses the query; at block 22, accesses a dense context corresponding to the query; at block 24, generates an updated query of the query using a dense context integrator and the dense context; at block 26, generates a response using a contextual response generation model and the update query; and at block 28, communicates the response as a response to the query. At block 30, the user client 160 receives the response; and at block 32 causes display of the response.

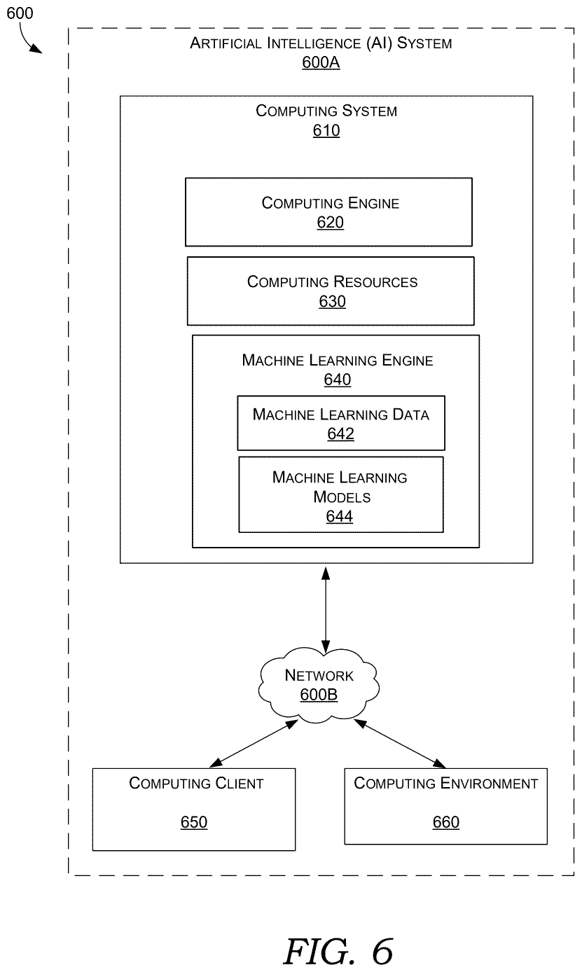

Aspects of the technical solution have been described by way of examples and with reference to FIGS. 1A, 1B, and 2. FIG. 1A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

### Example Methods

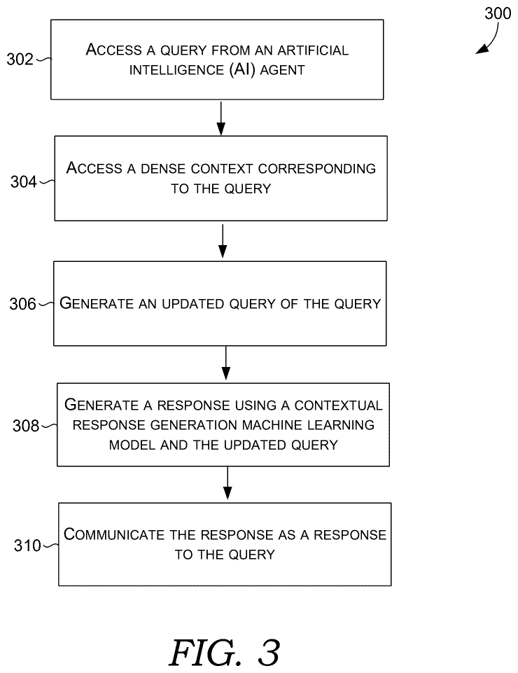

With reference to FIGS. 3, 4, and 5, flow diagrams are provided illustrating methods for providing dense context management using a dense context engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system).

Turning to FIG. 3, a flow diagram is provided that illustrates a method 300 for providing dense context management using a dense context engine in an artificial intelligence system. At block 302, access a query from an artificial intelligence (AI) agent. At block 304, access a dense context corresponding to the query. At block 306, generate an updated query of the query. At block 308, generate a response using a contextual response generation machine learning model and the updated query. At block 310, communicate the response as a response to the query.

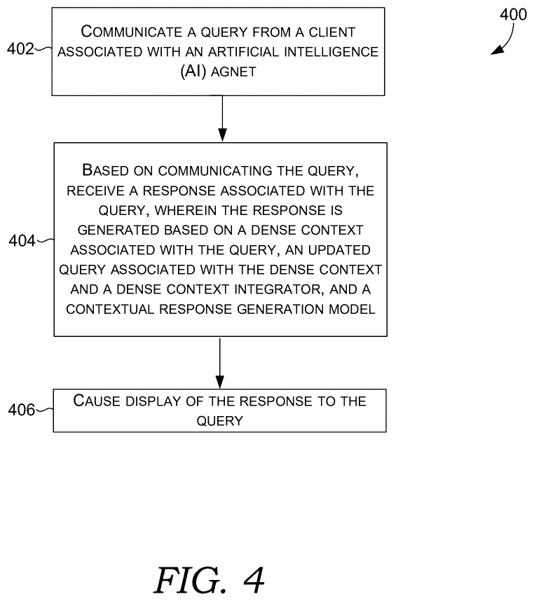

Turning to FIG. 4, a flow diagram is provided that illustrates a method 400 for providing dense context management using a dense context engine in an artificial intelligence system. At block 402, communicate a query from a client associated with an artificial intelligence (AI) agent. At block 404, based on communicating the query, receive a response associated with the query. The response is generated based on a dense context associated with the query, an updated query associated with the dense context and a dense context integrator, and a contextual response generation model. At block 406, causing display of the response to the query.

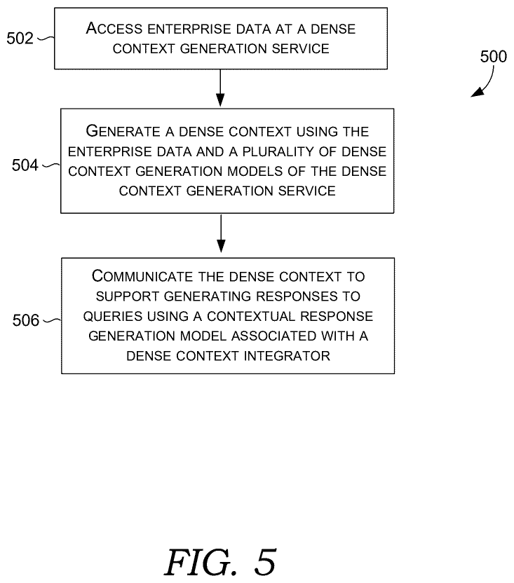

Turning to FIG. 5, a flow diagram is provided that illustrates a method 500 for providing dense context management using a dense context engine in an artificial intelligence system. At block 502, access enterprise data at a dense context generation service. At block 504, generate a dense context using the enterprise data and a plurality of dense context generation models of the dense context generation service. At block 506, communicate the dense context to support generating responses to queries using a contextual response generation model associated with a dense context integrator.

### Technical Improvement

Embodiments of the present techniques have been described with reference to several inventive features (e.g., operations, systems, engines, and components) associated with an artificial intelligence system. Inventive features described include: operations, interfaces, data structures, and arrangements of computing resources associated with providing the functionality described herein relative with reference to a dense context engine 110. Functionality of the embodiments of the present invention have further been described, by way of an implementation and anecdotal examples—to demonstrate that the operations for providing the dense context engine 110 as a solution to a specific problem in artificial systems technology to improve computing operations in artificial intelligence systems. By way of illustration, the dense context engine 110 supports identifying, curating, and synthesizing dense context, and further supports generating a contextually accurate response to queries using the dense context via the contextual response generation engine 150. The contextual response generation engine 150 can support integrating dense context with user queries to generate contextually accurate responses to user queries, including context associated with an enterprise and personal context associated with the user sending the query. In particular, the contextual response generation engine 150 may leverage AI in various ways to provide enhanced functionality and provide users with contextually accurate responses to queries that are specific to the user and/or the enterprise, including subgroups within the enterprise. For example, a user can provide a query to the contextual response system client 162 for the dense context engine 110 to generate a response, and the dense context engine 110, utilizing machine learning models, generates and utilizes dense context that is unique to an enterprise and the user to generate a contextually accurate response to the query. Hence the response that is generated by the dense context engine 110 for the user query is much better (e.g., more contextually accurate) than if the query was just processed using traditional methods.

### Additional Support for Detailed Description

### Example Artificial Intelligence (AI) System in a Computing Environment

Referring now to FIG. 6, FIG. 6 illustrates a computing environment in which implementations of the present disclosure may be employed. In particular, FIG. 6 shows a high level architecture of an example cloud computing platform 600, artificial intelligence (AI) system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services—including compute, servers, storage, databases, networking, and intelligence. The components of cloud computing environment 600 may communicate with each other over a network 600B which may include, without limitation, one or more local area networks (LANs) and/or wide area networks (WANs).

The AI system 600A provides a specialized infrastructure designed to support the computational demands of artificial intelligence (AI) workloads, including both training and inference tasks. The AI backend network systems 600A consists of interconnected components that facilitate the efficient processing, communication, and management of data within a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing engine 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### Example Distributed Computing System Environment

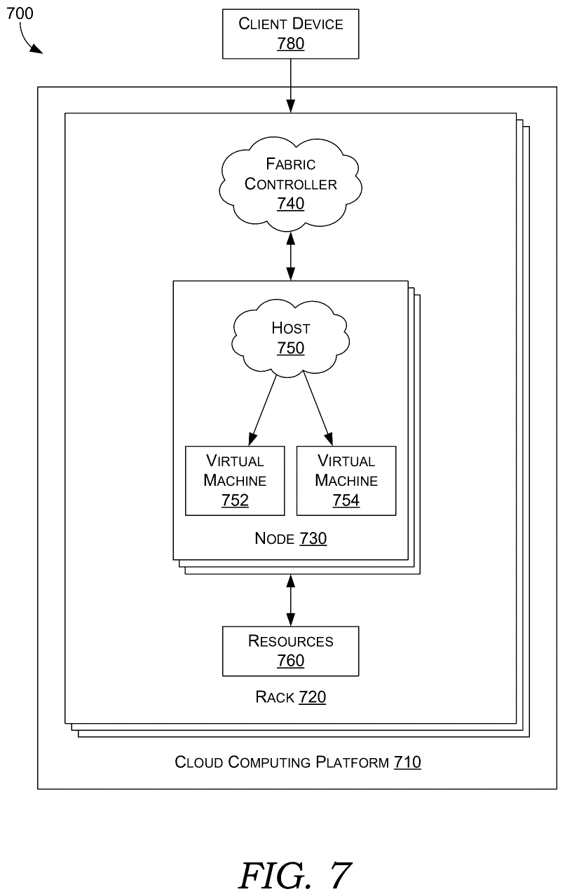

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

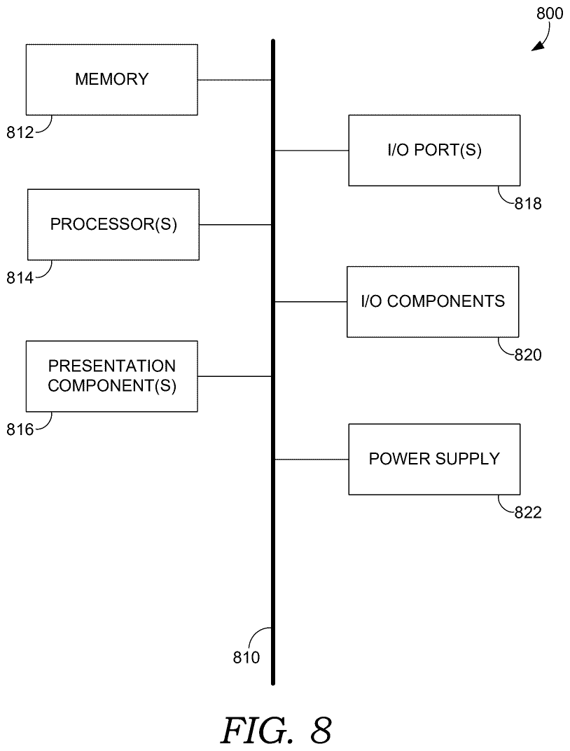

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a query from an artificial intelligence (AI) agent;
based on the query, accessing a dense context corresponding to the query, wherein the dense context is generated using a dense context generation service and enterprise data, the dense context is a programmatically-generated concise representation of data that provides context for language models to generate responses to queries;
using a dense context integrator and the dense context, generating an updated query of the query, wherein the dense context integrator supports integrating the dense context with the query to generate the updated query;
using a contextual response generation model and the updated query, generating a response; and
communicating the response as a response to the query.

2. The system of claim 1, wherein the dense context generation service is integrated into an enterprise computing environment associated with a plurality of enterprise data sources comprising the enterprise data, wherein the dense context generation service is a contextual summary service that programmatically transforms the enterprise data into the dense context.

3. The system of claim 1, wherein the dense context integrator is configured to transform the updated query into one or more additional queries.

4. The system of claim 1, wherein generating the response is further based on a Retrieval-Augmented Generation (RAG) model, the RAG model uses at least the updated query to retrieve RAG data including one or more documents from a RAG document repository and communicates the query and the RAG data to the contextual response generation model to cause generation of the response.

5. The system of claim 1, wherein the contextual response generation model is integrated in an enterprise computing environment to employ two or more of the following: the query, the updated query, a transformed updated query, RAG data, and the dense context to generate the response.

6. The system of claim 1, the operations further comprising:
communicating the query from a client associated with an artificial intelligence (AI) agent;
based on communicating the query, receiving the response associated with the query; and
causing display of the response.

7. The system of claim 1, the operations comprising:
accessing the enterprise data at a dense context generation service;
using the enterprise data and a plurality of dense context generation models of the dense context generation service; and
communicating the dense context to support generating the response to the query.

8. One or more computer-storage media having computer-executable instructions embodied thereon that, when executed by a computing system having a processor and memory, cause the processor to perform operations, the operations comprising:
communicating, a query from a client associated with an artificial intelligence (AI) agent;
based on communicating the query, receiving a response associated with the query, wherein the response is generated based on a dense context associated with the query, an updated query associated with the dense context and a dense context integrator, and a contextual response generation model, wherein the dense context is generated using a dense context generation service and enterprise data, the dense context is a programmatically-generated concise representation of data that provides context for language models to generate responses to queries; and
causing display of the response to the query.

9. The media of claim 8, wherein the dense context generation service is integrated into an enterprise computing environment associated with a plurality of enterprise data sources comprising the enterprise data, wherein the dense context generation service is a contextual summary service that programmatically transforms the enterprise data into the dense context.

10. The media of claim 8, wherein the dense context integrator supports integrating dense context with the query to generate the updated query, wherein the dense context integrator is configured to transform the updated query into one or more additional queries.

11. The media of claim 8, wherein generating the response is further based on a Retrieval-Augmented Generation (RAG) model, the RAG model uses at least the updated query to retrieve RAG data including one or more documents from a RAG document repository and communicates the query and the RAG data to the contextual response generation model to cause generation of the response.

12. The media of claim 8, wherein the contextual response generation model is integrated in an enterprise computing environment to employ two or more of the following: the query, the updated query, a transformed updated query, RAG data, and the dense context to generate the response.

13. The media of claim 8, wherein the AI agents supports a combination mode, an enterprise context mode, and a user context mode based at least in part on a hierarchical structure associated with the dense context.

14. The media of claim 8, wherein an interface of the client is configured to generate one or more interface elements associated with the response, wherein the response comprises one or more segments of the dense context.

15. A computer-implemented method, the method comprising:
accessing enterprise data at a dense context generation service;
using the enterprise data and a plurality of dense context generation models of the dense context generation service, generating a dense context, wherein the dense context is a programmatically-generated concise representation of data that provides context for language models to generate responses to queries; and
communicating the dense context to support generating a response to a query using a contextual response generation model associated with a dense context integrator, wherein the dense context integrator supports integrating the dense context with the query to generate an updated query.

16. The method of claim 15, wherein the dense context generation service is integrated into an enterprise computing environment associated with a plurality of enterprise data sources comprising the enterprise data, wherein the dense context generation service is a contextual summary service that programmatically transforms the enterprise data into dense contexts.

17. The method of claim 15, the operations further comprising:
accessing the query from an artificial intelligence (AI) agent;
based on the query, accessing the dense context corresponding to the query;
using a dense context integrator and the dense context, generating the updated query of the query;
using a contextual response generation model and the updated query, generating the response; and
communicating the response as a response to the query.

18. The method of claim 17, wherein the dense context integrator supports integrating dense context with the query to generate the updated query, wherein the dense context integrator is configured to transform the updated query into one or more additional queries.

19. The method of claim 17, wherein generating the response is further based on a Retrieval-Augmented Generation (RAG) model, the RAG model uses at least the updated query to retrieve RAG data including one or more documents from a RAG document repository and communicates the query and the RAG data to the contextual response generation model to cause generation of the response.

20. The method of claim 17, wherein the contextual response generation model is integrated in an enterprise computing environment to employ two or more of the following: the query, the updated query, a transformed updated query, RAG data, and the dense context to generate the response.
